(19) United States
(12) Patent Application Publication
(10) Pub. No.: US 2010/0037493 A1
(43) Pub. Date: Feb. 18, 2010

(54) Wear-Resistant, Impact-Resistant Excavator Bucket Manufactured by Casting and Manufacturing Method Thereof

(76) Inventors: Jong-Soo Kim, Busan (KR); Kyu-Young Lee, Busan (KR)

Correspondence Address: PARK LAW FIRM, 3255 WILSHIRE BLVD, SUITE 1110, LOS ANGELES, CA, 90010, US

(21) Appl. No.: 12/190,507

(22) Filed: Aug. 12, 2008

(51) Int. Cl. E02F 3/40; B23P 17/00; B23P 11/00

(52) U.S. Cl. 37/444; 164/6; 29/527.6; 29/428

(57) ABSTRACT

An excavator bucket is manufactured by: making a wooden or metallic casting pattern; inserting the casting pattern into a molding box and subjecting the inserted pattern to sand casting; taking out the pattern from the molding box to form a mold cavity; heating an ingot at a temperature of 1600-1650° C., and pouring the heated ingot into the mold cavity; solidifying the poured ingot and separating the upper mold portion and the molding box from the solidified ingot, thus producing a sand-cast bucket; charging the sand-cast bucket into an electric furnace, heating the charged bucket at a temperature of 900-1100° C., and quenching the heated bucket in cold water; subjecting the coupling part of the quenched bucket to boring, face milling, drilling and tapping; assembling parts, bushings, pins and bolts, to the coupling part; and washing, drying and painting the assembled bucket.

### BACKGROUND OF THE INVENTION

1. Field of the Invention

The present invention relates to a wear-resistant, impact-resistant excavator bucket, which is manufactured by casting, can be used for a long period of time without being broken, and is mainly used to quarry aggregates and stones (for example, to excavate rocky mountains, consisting mainly of rock layers, or rocks, to select garden stones), pull rocks, carry rocks and load rocks in trucks, as well as a manufacturing method thereof.

2. Background of the Related Art

As shown in FIGS. 6 and 7, an excavator bucket 1 according to the prior art comprises a back plate 2, left and right side plates 3 attached to the left and right sides of the back plate, side edges 12 welded to the front ends of the left and right side plates, respectively, a shovel member 4 attached to the lower end of the back plate 2 in the widthwise direction, and a plurality of tooth adapters 5 welded to the shovel member 4 at a given interval.

In FIG. 6, the dotted lines schematically show welded joints.

In order to manufacture the prior excavator bucket 1, welding parts are repeatedly welded using low electric currents. In this welding method, the welding amount is small, and thus welding parts must be repeatedly welded. For this reason, the welded joints have a convex bead shape, and the texture of portions surrounding the welded joints is changed due to heat generated during the welding process. Due to this change, the base material is excessively welded, leading to an undercut phenomenon in which the base material portion connected with the end of the welding part is dented. Thus, the durability of the base material is reduced, such that the base material can be broken when an impact is applied thereto. Also, because the welding part is welded several times, boundaries and pores occur due to the difference in cooling rate between a part, which is welded for the first time, and a part, which is welded later, and the undercuts, the boundaries and the pores are responsible for cracks.

Accordingly, while the prior excavator bucket repeatedly colloids with earth, soil and stones during excavation operations, the side edges 12 or the shovel member 4 is easily worn away and is detached, and the welding joint is damaged and is frequently broken.

The prior excavator bucket as described above has problems in that it is manufactured through a complicated process, and the durability thereof is reduced due to a welding process, such that the steel plates thereof are torn during excavation operations in stony mountains, thus reducing the life span thereof and greatly increasing the maintenance cost thereof. Also, there are problems in that, because the prior excavator bucker is manufactured using commercial weldable steel plates, it has limited mechanical properties, and thus it is severely worn away during excavation operations and is weak against impact, such that it is frequently replaced, leading to a decrease in operation efficiency and an increase in expense.

### SUMMARY OF THE INVENTION

Accordingly, the present invention has been made in an effort to solve the above-mentioned problems associated with the prior art, and it is an object of the present invention an excavator bucket which can be manufactured in a simple process by designing an integral cast structure in view of the thickness and shape of each part of the bucket, such that the bucket can be produced by casting, and manufacturing the bucket based on the integral structure design using a specific alloy by casting.

Another object of the present invention is to provide an excavator bucket which has excellent mechanical properties, including high wear resistance and impact resistance, and thus has extended life span and improved quality.

To accomplish the above objects, in one aspect, the present invention provides a wear-resistant, impact-resistant excavator bucket manufactured by casting, which comprises an excavator bucket body, comprising a back plate, a support plate and left and right side plates, which are integrally formed by casting.

Preferably, the wear-resistant, impact-resistant excavator bucket further comprises: cast side edges detachably fixed to the front ends of the left and right plates of the excavator bucket body by means of bolts and nuts; cast U-shaped shovel members 150 inserted onto the lower end of the support plate so as to be arranged in the widthwise direction of the support plate; a plurality of tooth adapter-fixing members arranged between the shovel members at a given interval; and tooth adapters coupled to the ends of the tooth adapter-fixing members.

In another aspect, the present invention provides a wear-resistant, impact-resistant excavator bucket, which is manufactured by casting using a method comprising: making a wooden or metallic casting pattern having the same shape as that of the bucket; inserting the casting pattern into a molding box and subjecting the inserted pattern to sand casting using molding sand so as to form a sprue; taking out the pattern from the molding box to form a mold cavity; heating an ingot, comprising a silicon (Si)-chromium (Cr)-manganese (Mn) alloy as a base, bromine (B) and the balance of Fe and unavoidable impurities, at a temperature of 1600-1650° C., and pouring the heated ingot into the mold cavity; solidifying the poured ingot and separating the upper mold portion and the molding box, thus producing a sand-cast bucket; charging the sand-cast bucket into an electric furnace, heating the charged bucket at a temperature of 900-1100° C., and quenching the heated bucket in cold water; subjecting the coupling part of the quenched bucket to boring, face milling, drilling and tapping, such that the bucket can be coupled to an excavator body; assembling parts, bushings, pins and bolts, to the coupling part; and washing, drying and painting the assembled bucket.

In the wear-resistant, impact-resistant excavator bucket according to the present invention, the ingot is preferably a high-manganese steel, comprising 0.90-1.35 wt % C, 0.30-0.80 wt % Si, 11-14 wt % Mn, less than 0.10 wt % P, less than 0.50 wt % S, less than 0.005 wt % B and the balance of Fe and unavoidable impurities.

In the wear-resistant, impact-resistant excavator bucket according to the present invention, the ingot is preferably a high-tension carbon steel for casting, comprising 0.17-0.50 wt % C, 0.30-0.80 wt % Si, 0.50-1.60 wt % Mn, less than 0.030 P, less than 0.030 wt % S. less than 0.005 wt % B and the balance of Fe and unavoidable impurities.

In still another aspect, the present invention provides a method of manufacturing a wear-resistant, impact-resistant excavator bucket by casting, the method comprising the steps of: making a wooden or metallic casting pattern mold having the same shape as that of the bucket; inserting the casting pattern into a molding box and subjecting the inserted pattern to sand casting so as to form a sprue; taking out the casting pattern from the molding box to form a mold cavity after the sand casting; placing an upper mold portion, having a gate and sprue formed therein, in the upper portion of the molding box, heating an ingot, comprising a silicon (Si)-chromium (Cr)-manganese (Mn) alloy as a base, bromine (B) and the balance of Fe and unavoidable impurities, at a temperature of 1600-1650° C., pouring the heated ingot into the gate so as to fill the mold cavity with the heated ingot; solidifying the poured ingot, and separating the molding flask and the upper mold portion from the solidified ingot, thus producing a sand-cast bucket; charging the sand-cast bucket into an electric furnace, heating the charged bucket at a temperature of 900-1100° C., and quenching the heated bucket in cold water; subjecting the coupling part of the quenched bucket to machining operations, including boring, face milling, drilling and tapping, such that the bucket can be coupled to an excavator body; assembling parts, including bushings, pins and bolts, to the machined bucket; and washing and drying the assembled bucket and painting the dried bucket to protect the outer surface of the bucket.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of decomposed parts of an excavator bucket manufactured by casting according to the present invention;

FIG. 2 is a perspective view of an excavator bucket manufactured by casting according to the present invention;

FIG. 3 is a perspective view of combined parts of an excavator bucket manufactured by casting according to the present invention;

FIG. 4 is a side view of an excavator bucket manufactured by casting according to the present invention;

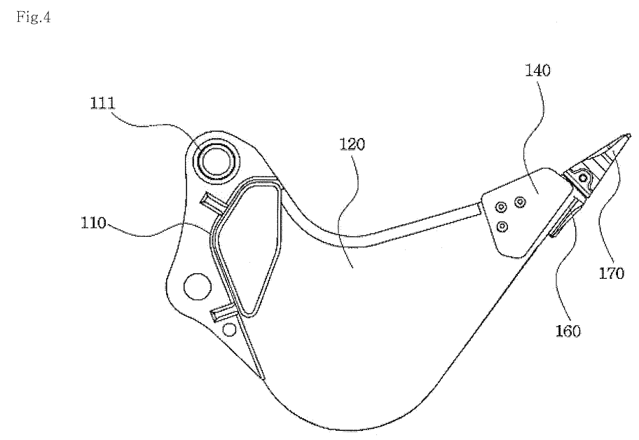

FIG. 5 is a flowchart showing a process for manufacturing an excavator bucket according to the present invention;

FIG. 6 is a perspective view of decomposed parts of an excavator bucket according to the prior art; and

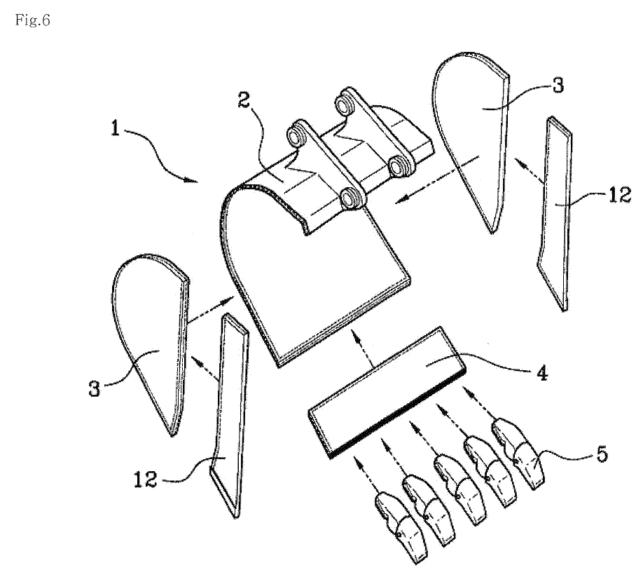

FIG. 7 is a perspective view of combined parts of an excavator bucket according to the prior art.

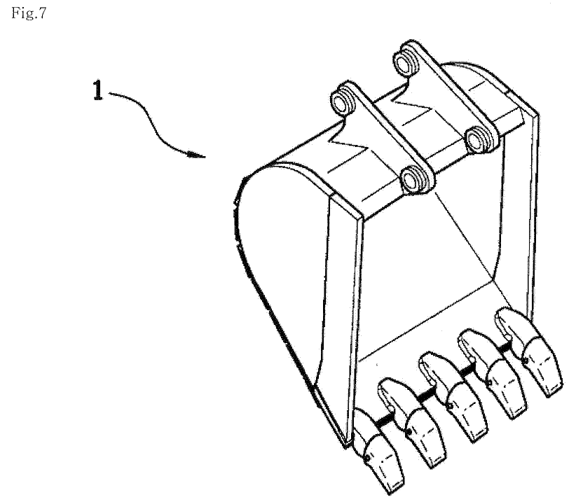

### DETAILED DESCRIPTION OF THE PREFERRED EMBODIMENT

Embodiments of a wear-resistant, impact-resistant excavator bucket of the present invention, manufactured by casting, and a manufacturing method thereof, will be described in detail with reference to the accompanying drawings.

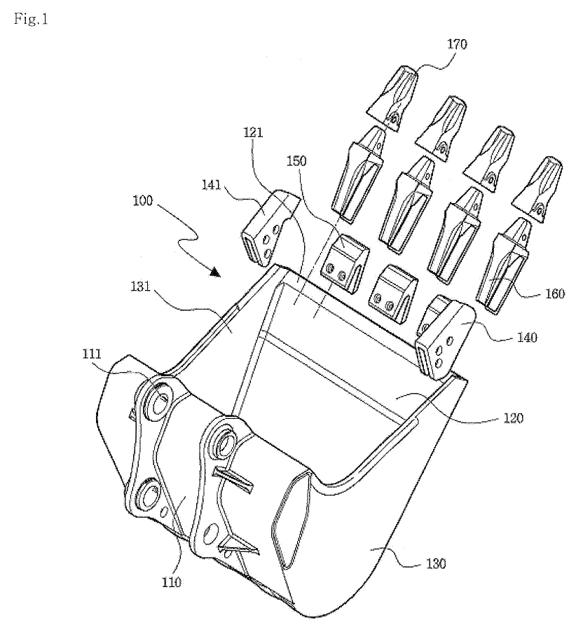

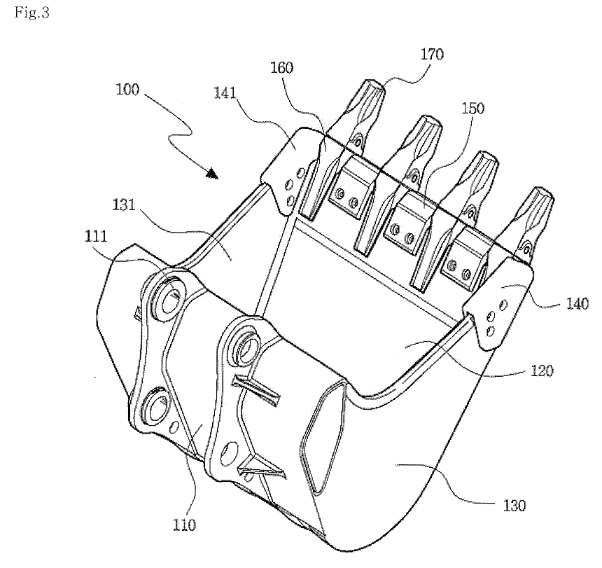

As shown FIGS. 1 to 3, an excavator bucket body 100 according to the present invention comprises a back plate 110, a support plate 120 and left and right side plates 130 and 131, which are integrally formed by casting.

To the front ends of the left and right side plates 130 and 131 of the excavator bucket body 100, are detachably fixed side edges 140 and 141 by means of bolts and nuts. Onto the lower end of the support plate 120, are detachably inserted cast U-shaped shovel members 150 so as to be arranged in the widthwise direction of the support plate 120. Between the U-shaped shovel members 150, a plurality of tooth adapter-fixing members 160 are coupled at a given interval, and to the ends of the tooth adapter-fixing members 160, tooth adapters 170 are coupled.

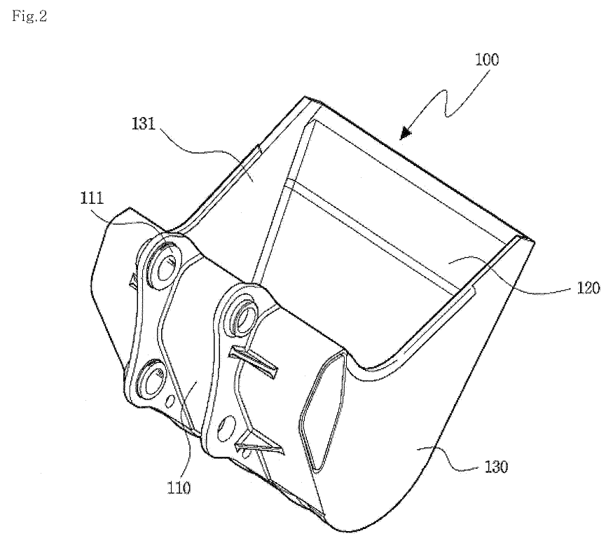

Herein, the tooth adapters 170 coupled to the plurality of tooth adapter-fixing members 160 may have varying strength and wear resistance characteristics depending on the intended uses thereof, including breaking the rocks of stony mountains, excavating earth, scooping sand, etc. For this reason, as shown in FIG. 2, parts except for the cast U-shaped shovel members 150, the tooth adapter-fixing members 160 and the tooth adapters 170 are integrally formed by casting, and then the U-shaped shovel members 150 and the tooth adapter-fixing members 160 are coupled to the end 121 of the support plate 120 either by bolts and nuts or by welding.

Preferably, in the present invention, in order to manufacture an cast integral excavator bucket having high strength, high hardness, excellent wear resistance and excellent hardenability, a silicon-chromium-molybdenum alloy is used as a base, and bromine (B) is added thereto in order to improve hardenability and wear resistance.

Specifically, an excavator bucket body 100 according to a first embodiment of the present invention is manufactured using an ingot, which is a high-manganese steel comprising 0.90-1.35 wt % C, 0.30-0.80 Si, 11-14 wt % Mn, less than 0.005 wt % B and the balance of Fe and other unavoidable impurities.

The reason for the limit of the range of each component of the steel according to the first embodiment of the present invention is as follows

### First Embodiment

Carbon (C): 0.90-1.35 wt %

Carbon is an element that determines the strength and hardness of the steel, particularly the weldability and toughness of the steel.

As the content of C increases, the strength of the steel increases, but the toughness of the steel can decreases.

If the content of C is low, the toughness of the steel increases, but the strength of the steel decreases.

For this reason, in the present invention, the content of C is limited to the range of 0.90-1.35 wt % in order to ensure a tensile strength of more than 60 kgf/mm² and a surface hardness of more than 200 HB in an air-cooled state.

Si: 0.30-0.80 wt %

Si acts as a deoxidizer in a steel manufacturing process, and when it is added in a suitable amount, it inhibits the growth of austenite grains and provides solid solution strengthening to increase the strength of the steel.

However, if it is added in an amount of less than 0.30 wt %, the effect thereof will be insufficient, and if it exceeds 0.80 wt %, the sensitivity to temper brittleness will increase.

For this reason, Si is limited to the range of 0.4-0.8 wt %.

Mn: 11-14 wt %

Mn acts to enhance hardenability and solid solution strengthening effects to increase strength. If it is excessively added, it will impair weldability. Thus, it is generally limited to 0.5-1.5 wt %.

However, in the present invention, the bucket body 100 is not manufactured by welding, but is manufactured by casting. For this reason, the content of Mn is limited to the range of 11-14 wt % to improve the hardenability of the steel during annealing, thus increasing the strength of the steel.

B: less than 0.005 wt %

B is known as an element that greatly improves hardenability, even when it is added in a very small amount.

In the steel of the present invention, which contains Cr in an amount lower than that in general high-tensile steel and contains no expensive Ni and Mo, the addition of B is necessary in order to ensure the hardenability of the steel.

In order to ensure the hardenability of the steel, B must be added in amount of at least 0.001 wt %. If the content of B increases, the hardenability of the steel can be reduced. For this reason, the content of B is preferably limited to less than 0.005%.

### Second Embodiment

The ingot described in the first embodiment may also be a high-tension carbon steel for casting, which comprises 0.17-0.50 wt % C, 0.30-0.80 wt % Si, 0.50-1.60 wt % Mn, less than 0.005 wt % B and the balance of Fe and unavoidable impurities.

As described above, because the excavator bucket body 100 according to the embodiment of the present invention is manufactured using the high-manganese steel or the high-tension carbon steel for casting, which contain a bromine (B) element and have strong wear resistance, it may have improved wear resistance, impact resistance and durability compared to those of existing excavator buckets made of general steel plates.

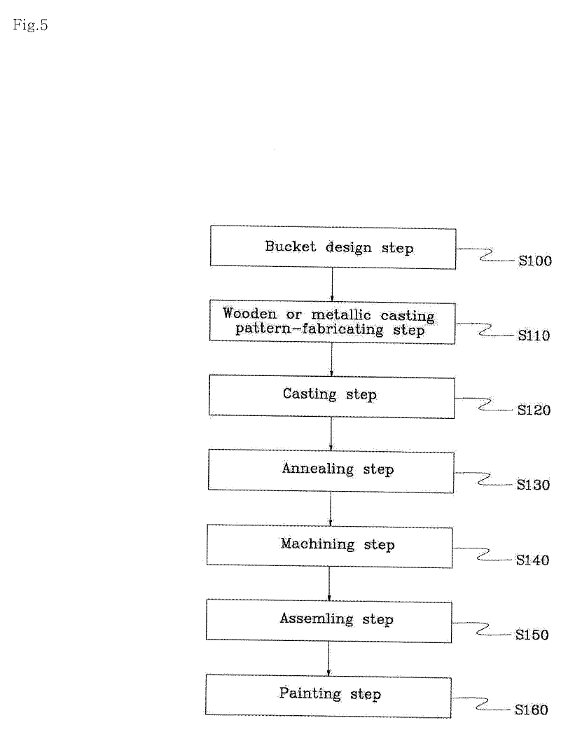

Hereinafter, a method of manufacturing the excavator bucket by casting using the above-described alloy steel will be described in further detail with reference to FIG. 5.

1. Bucket Design Step (S100)

An integral cast structure is designed in view of the thickness and shape of each part of the bucket, such that the bucket can be produced by casting.

2. Wooden or Metallic Pattern-Fabricating Step (S110)

Then, a wooden or metallic pattern having the same shape as that of the excavator bucket of the present invention is fabricated.

Specifically, a molding design is made based on the drawing of the integral structure design, such that steel casting is possible. The casting pattern is fabricated in view of the size, number and location of risers and the location and shape of a gate, such that it comprises separable upper and lower pattern portions, cores and the like and can be subjected to sand casting. A portion of the cores is fabricated using a shell mold in order to make production easy.

3. Casting Step (S120)

Then, the casting pattern is inserted into a molding box, in which it is then subjected to sand casting using molding sand so as to form a gate. After the sand casting, the pattern is taken out of the molding boxy to form a mold cavity.

The upper mold portion having the gate and sprue formed therein is placed in the upper portion of the molding box. Then, an ingot, which comprises a silicon (Si)-chromium (Cr)-manganese (Mn) as a base, bromine (B) and the balance of iron (Fe) and unavoidable impurities, is heated at a temperature of 1600-1650° C., and the heated ingot is poured into the gate by gravity, so as to fill the cavity with the ingot.

After the poured ingot is solidified, the upper mold portion and the molding box are separated from the solidified ingot, thus producing a sand-cast bucket.

4. Annealing Step (S130)

The sand-cast bucket is charged into an electric furnace, and then heated at a temperature of 900-1100° C., and the heated bucket is quenched in cold water.

If the heating temperature is lower than 900° C., an excessive rolling load will be applied to the steel during a rolling process due to an increase in deformation resistance, and if the heating temperature is higher than 1100° C., the steel texture will become non-uniform due to the abnormal growth of austenite grains to impair the toughness of the steel and, in addition, the hardenability of the steel will be reduced due to an increase in the content of nitrogen dissolved in the steel, leading to a decrease in the strength of the steel.

By the above-described annealing process, the texture of the cast steel becomes uniform, the toughness of the steel is increased, and the processing of the steel becomes easy.

5. Machining Step (S140)

Then, the coupling part 111 of the annealed excavator bucket is subjected to machining operations, including boring, face milling, drilling and tapping, such that the bucket can be coupled to an excavator body.

6. Assembling Step (S150)

Then, parts, including bushings, pins and bolts, are assembled to the machined coupling part of the bucket.

7. Painting Step (S160)

After the completion of the assembling step, the bucket is washed, dried and painted.

As apparent from the foregoing, according to the present invention, the excavator bucket can be manufactured in a simple process by designing an integral cast structure in view of the thickness and shape of each part of the bucket, such that the bucket can be produced by casting, and manufacturing the bucket based on the integral structure design using a specific alloy by casting. Also, the excavator bucket manufactured according to the present invention has excellent mechanical properties, including high wear resistance and impact resistance, and thus has extended life span and improved quality.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A wear-resistant, impact-resistant excavator bucket manufactured by casting, which comprises an excavator bucket body 100, comprising a back plate 110, a support plate 120 and left and right side plates 130 and 131, which are integrally formed by casting.

2. The wear-resistant, impact-resistant excavator bucket of claim 1, which further comprises: cast side edges 140 and 141 detachably fixed to the front ends of the left and right plates 130 and 131 of the excavator bucket body 100 by means of bolts and nuts; cast U-shaped shovel members 150 inserted onto the lower end of the support plate 120 so as to be arranged in the widthwise direction of the support plate; a plurality of tooth adapter-fixing members 160 arranged between the shovel members 150 at a given interval; and tooth adapters 170 coupled to the ends of the tooth adapter-fixing members 160.

3. A wear-resistant, impact-resistant excavator bucket, which is manufactured by casting using a method comprising: making a wooden or metallic casting pattern having the same shape as that of the bucket; inserting the casting pattern into a molding box and subjecting the inserted pattern to sand casting using molding sand so as to form a sprue; taking out the pattern from the molding box to form a mold cavity; heating an ingot, comprising a silicon (Si)-chromium (Cr)-manganese (Mn) alloy as a base, bromine (B) and the balance of Fe and unavoidable impurities, at a temperature of 1600-1650° C., and pouring the heated ingot into the mold cavity; solidifying the poured ingot and separating the upper mold portion and the molding box, thus producing a sand-cast bucket; charging the sand-cast bucket into an electric furnace, heating the charged bucket at a temperature of 900-1100° C., and quenching the heated bucket in cold water; subjecting the coupling part of the quenched bucket to boring, face milling, drilling and tapping, such that the bucket can be coupled to an excavator body; assembling parts, bushings, pins and bolts, to the coupling part; and washing, drying and painting the assembled bucket.

4. The wear-resistant, impact-resistant excavator bucket of claim 3, wherein the ingot is a high-manganese steel, comprising 0.90-1.35 wt % C, 0.30-0.80 wt % Si, 11-14 wt % Mn, less than 0.10 wt % P, less than 0.50 wt % S, less than 0.005 wt % B and the balance of Fe and unavoidable impurities.

5. The wear-resistant, impact-resistant excavator bucket of claim 3, wherein the ingot is a high-tension carbon steel for casting, comprising 0.17-0.50 wt % C, 0.30-0.80 wt % Si, 0.50-1.60 wt % Mn, less than 0.030 P, less than 0.030 wt % S, less than 0.005 wt % B and the balance of Fe and unavoidable impurities.

6. A method of manufacturing a wear-resistant, impact-resistant excavator bucket by casting, the method comprising the steps of:
making a wooden or metallic casting pattern mold having the same shape as that of the bucket;
inserting the casting pattern into a molding box and subjecting the inserted pattern to sand casting so as to form a sprue;
taking out the casting pattern from the molding box to form a mold cavity after the sand casting;
placing an upper mold portion, having a gate and sprue formed therein, in the upper portion of the molding box, heating an ingot, comprising a silicon (Si)-chromium (Cr)-manganese (Mn) alloy as a base, bromine (B) and the balance of Fe and unavoidable impurities, at a temperature of 1600-1650° C., pouring the heated ingot into the gate so as to fill the mold cavity with the heated ingot;
solidifying the poured ingot, and separating the molding flask and the upper mold portion from the solidified ingot, thus producing a sand-cast bucket;
charging the sand-cast bucket into an electric furnace, heating the charged bucket at a temperature of 900-1100° C., and quenching the heated bucket in cold water;
subjecting the coupling part of the quenched bucket to machining operations, including boring, face milling, drilling and tapping, such that the bucket can be coupled to an excavator body;
assembling parts, including bushings, pins and bolts, to the machined bucket; and
washing and drying the assembled bucket and painting the dried bucket to protect the outer surface of the bucket.
